(19) United States
(12) Patent Application Publication
(10) Pub. No.: US 2026/0176510 A1
(43) Pub. Date: Jun. 25, 2026

(54) POLYURETHANE ADHESIVE FOR PACKAGING MATERIALS FOR BATTERIES AND PACKAGING MATERIAL FOR BATTERIES INCLUDING THE SAME

(71) Applicant: SEOWOO ADVANCED MATERIAL CO.,LTD, Gyeongsangbuk-Do (KR)

(72) Inventors: Soon Yong Seo, Daejeon (KR); Jong Ho Jung, Gyeonggi-Do (KR); Dong Yong Shin, Seoul (KR)

(21) Appl. No.: 19/329,146

(22) Filed: Sep. 15, 2025

(30) Foreign Application Priority Data
Dec. 20, 2024 (KR) 10-2024-0193288

(51) Int. Cl. C09J 175/06; C08G 18/42; H01M 50/119; H01M 50/121; H01M 50/124

(52) U.S. Cl. CPC C09J 175/06; C08G 18/4216; H01M 50/119; H01M 50/121; H01M 50/124

(57) ABSTRACT

Provided is a polyurethane adhesive for a battery packaging material, the polyurethane adhesive including a main agent and a polyisocyanate curing agent, wherein the main agent includes polyester polyol of which number-average molecular weight (Mn) is 20,000 to 33,000 g/mol and a glass transition temperature is 1 to 18° C., and provided is a packaging material for batteries including the polyurethane adhesive.

### CROSS-REFERENCE TO RELATED APPLICATION(S)

This application claims the benefit of Korean Patent Application No. 10-2024-0193288, filed on Dec. 20, 2024, in the Korean Intellectual Property Office, the disclosure of which is incorporated herein by reference.

### BACKGROUND

### 1. Field of the Invention

The present invention relates to a polyurethane adhesive for battery packaging materials and a packaging material for batteries including the same.

### 2. Description of the Related Art

Lithium ion batteries play an important role in various fields depending on their performance and use, and are the most widely used secondary battery technology. One of the important factors that determines the performance of a battery is the battery's outer package, and the outer package safely contains the electrodes and electrolytes and protects them from the external environment. In existing technology, metal cans are widely used as the outer package for lithium ion batteries. The metal cans are sturdy and have excellent resistance to boiling water, so the metal cans can reliably protect the battery cells. However, the metal cans are relatively heavy and expensive, and there are also disadvantages in terms of productivity.

Recently, as the demand for weight reduction and cost reduction increases, packaging materials that laminate plastic film or metal foil are mainly used as the outer package of lithium ion batteries. Such packaging materials are lighter and have lower production costs than metal cans, and such packaging materials have a high degree of shape freedom, allowing optimization of battery design and size. Further, the packaging materials are flexible and can respond well to battery expansion, and the packaging materials have the advantage of being able to be manufactured in various sizes and shapes.

However, such packaging materials that laminate plastic films or metal foils can cause problems in high-temperature environments in terms of adhesive strength and the resistance to boiling water. Lithium ion batteries generate heat during the charging and discharging process, and the outer package of the battery is continuously exposed to the heat. Thus, the adhesive strength of the packaging material may be reduced or the layers may become lifted, and this causes the poor appearance and may negatively affect the stability and performance of the battery. Therefore, there is a need to solve such problems.

### SUMMARY

An aspect provides a polyurethane adhesive for a battery packaging material that has excellent formability and exhibits excellent adhesive strength even at high temperatures, and with excellent resistance to boiling water by which there is no interlayer lifting phenomenon without a decrease in interlayer adhesive strength, and provides a packaging material for batteries that includes the same.

According to an aspect, there is provided a polyurethane adhesive for a battery packaging material, the polyurethane adhesive including a main agent and a polyisocyanate curing agent. The main agent includes polyester polyol of which number-average molecular weight (Mn) is 20,000 to 33,000 g/mol and a glass transition temperature is 1 to 18° C.

According to an example embodiment, a weight-average molecular weight (Mw) of the polyester polyol may be 30,000 to 90,000 g/mol.

According to an example embodiment, polydispersity index (PDI) of the polyester polyol may be 2 to 3.

According to an example embodiment, an acid value of the polyester polyol may be 0.25 to 0.9 mgKOH/g.

According to an example embodiment, a hydroxyl value of the polyester polyol may be 3.5 to 8 mgKOH/g.

According to an example embodiment, the polyester polyol may be derived from reaction of a polyacid component and a polyalcohol component.

According to an example embodiment, the polyacid component may include at least one selected from a group consisting of an aromatic polyacid component composed of terephthalic acid, isophthalic acid, naphthalene dicarboxylic acid, phthalic anhydride and ester compounds thereof, and an aliphatic polyacid component composed of azelaic acid, dimerized fatty acids, adipic acid, sebacic acid, tetrahydrophthalic anhydride, hexahydrophthalic anhydride, succinic acid, glutaric acid, malonic acid, oxalic acid, pimelic acid and ester compounds thereof.

According to an example embodiment, molar content of the aromatic polyacid component relative to a total polyacid component of the polyester polyol may be 40 to 90 mol %.

According to an example embodiment, the polyalcohol component may include at least one selected from a group consisting of neopentyl glycol, ethylene glycol, diethylene glycol, triethylene glycol, MP Diol (2-Methyl-1,3-propanediol), propylene glycol, dipropylene glycol, 1,6-hexanediol, 1,4-1,4-butylene glycol, 1,4-cyclohexanedimethanol, trimethylolpropane, glycerin, 1,9-nonanediol, polyether polyol, polycarbonate polyol, polyolefin polyol, acrylic polyol, polyurethane polyol, 1,2-butanediol, 1,3-butanediol, 1,2-hexanediol, 1,3-propanediol and pentaerythritol.

According to an example embodiment, the polyacid component may include (a) terephthalic acid, (b) isophthalic acid, and (c) azelaic acid or sebacic acid.

According to an example embodiment, the polyacid component may include (a) 20 to 45 mol % of terephthalic acid, (b) 25 to 35 mol % of isophthalic acid, and (c) 20 to 50 mol % of azelaic acid or sebacic acid.

According to an example embodiment, the polyacid component may further include more than 0 and less than 8 mol % dimerized fatty acids.

According to an example embodiment, the polyalcohol component may include neopentyl glycol and ethylene glycol.

According to an example embodiment, the polyalcohol component may include 1 to 30 mol % of neopentyl glycol and 60 to 90 mol % of ethylene glycol.

According to an example embodiment, the polyalcohol component may further include greater than 0 and less than or equal to 30 mol % MPD (3-Methyl-1,5-pentanediol).

According to an example embodiment, the polyester polyol may include 70 to 120 mol of polyacid component per 100 mol of polyalcohol component.

According to an example embodiment, for 100 weight of the polyester polyol, 5 to 30 weight of polyisocyanate curing agent may be included.

According to another aspect, there is provided a packaging material for batteries where an outer resin film layer, an outer adhesive layer, a metal foil layer, an inner adhesive layer and a heat sealing layer are sequentially laminated. The outer adhesive layer includes a polyurethane adhesive for a battery packaging material, the polyurethane adhesive including a main agent and a polyisocyanate curing agent, and the main agent includes polyester polyol of which number-average molecular weight (Mn) is 20,000 to 33,000 g/mol, and of which glass transition temperature is 1 to 18° C.

According to an example embodiment, the outer resin film layer may be a polyamide film, a polyester film or nylon, and the heat sealing layer may be a polyolefin film.

Additional aspects of example embodiments will be set forth in part in the description which follows and, in part, will be apparent from the description, or may be learned by practice of the disclosure.

According to example embodiments, it is possible to provide an adhesive for a battery packaging material that has excellent formability and exhibits excellent adhesive strength even at high temperatures, and with excellent resistance to boiling water by which there is no interlayer lifting phenomenon without a decrease in interlayer adhesive strength, and provide a packaging material for batteries that includes the adhesive.

### DETAILED DESCRIPTION

Terms or words used in the present disclosure and claims should not be construed as limited to their ordinary or dictionary meanings. The terms or words must be interpreted with meaning and concept consistent with the technical idea of the present disclosure based on the principle that an inventor can appropriately define terminological concepts in order to explain his or her present disclosure in the best way.

Therefore, example embodiments described in the present disclosure are only the most preferred embodiments of the present disclosure, and the example embodiments do not represent the entire technical idea of the present disclosure. Accordingly, at the time of filing the present disclosure, there may be various equivalents and modifications that can replace them.

In the present disclosure, singular expressions include plural expressions unless the context clearly dictates otherwise.

Throughout the specification, when a part is described as “comprising or including” a component, it does not exclude another component but may further include another component unless otherwise stated. Therefore, for example, a structure containing A may further include components other than A. The term “comprising” is also a specific embodiment thereof, and also includes the more limited meanings “consisting essentially of” and “consisting of.” For example, A “structure comprising A” may also (essentially/essentially) consist of compound A.

The terms “equipped with” “have,” “may have,” “include,” and “may include” as used herein indicate the presence of corresponding features (for example, elements such as numerical values, functions, operations, or parts), and do not preclude the presence of additional features.

In the present disclosure, when any layer is said to be located “on” or “between” another layer, it includes not only cases where any layer is in contact with that another layer, but also cases where there are other layers or materials between the two layers.

In the present disclosure, when an amount, concentration, or other value or parameter is given as a range, preferred range, or enumeration of upper and preferred lower values, it should be understood as specifically disclosing all ranges that can be formed by any upper range limit or desired value and any lower range limit or desired value of a random pair regardless of whether the scope is separately disclosed. When ranges of numerical values are stated herein, unless otherwise stated, for example, unless there is a qualifying term such as greater than, less than, and so on, the range is intended to include the endpoint value and all integers and fractions within the range. The scope of the present disclosure is not intended to be limited to the specific values recited when defining the scope.

If the measurement temperature affects material properties described with a specific example embodiment among physical properties described in the present disclosure, unless otherwise specified, the physical properties are measured at room temperature. The term room temperature is the natural temperature that is not heated or cooled. For example, the term room temperature may indicate any temperature in the range of about 10° C. to 30° C., about 23° C., or about 25° C. Further, unless otherwise specified, the unit of temperature in this specification is ° C.

Further, when the measured pressure affects the material properties described with a specific example embodiment among physical properties described in the present disclosure, unless otherwise specified, the physical properties are measured at normal pressure, that is, atmospheric pressure (about 1 atmosphere).

The first aspect of the present disclosure relates to a polyurethane adhesive for a battery packaging material.

The polyurethane adhesive for a battery packaging material may include, for example, a main agent and a polyisocyanate curing agent. The adhesive of the present disclosure may be a so-called two-component mixed adhesive that mixes the main agent and curing agent when used, a single-component adhesive in which the main agent and curing agent are pre-mixed, or an adhesive in which multiple main agents and/or multiple curing agents are mixed when used.

The main agent may include, for example, polyester polyol. The main agent may contain, for example, 10 to 60 wt % of polyester polyol, and in another example embodiment, the main agent may be contained in an amount of 20 to 40 wt %, but the main agent is not limited thereto. For example, the main agent may further include one or more solvents selected from the group consisting of methyl ethylketone, acetone, toluene, isopropyl alcohol, acetic acid ethyl, N-butyl acetate, dimethyl formamide, methylisobutylketone and cyclohexanone. For example, the main agent may contain 50 to 90 wt % of solvent, and in another example embodiment, the main agent may contain 60 to 80 wt % of solvent, but the main agent is not limited thereto.

For example, the polyester polyol may have a number-average molecular weight (Mn) of 20,000 to 33,000 g/mol. The number-average molecular weight may be measured according to a method described in Evaluation Example below, for example. In another example embodiment, the polyester polyol may have a number-average molecular weight (Mn) of 21,000 g/mol or greater, 22,000 g/mol or greater, or 23,000 g/mol or greater, or may have a number-average molecular weight (Mn) of 32,000 g/mol or less or 31,000 g/mol or less. By controlling the number-average molecular weight (Mn) of polyester polyol as described above, provided may be an adhesive with controlled peeling phenomenon and excellent adhesive strength at high temperatures. The coating performance during the adhesive manufacturing process may also be excellent.

For example, the polyester polyol may have a glass transition temperature (Tg) of 1 to 18° C. For example, the glass transition temperature may be measured in a manner according to the Evaluation Example described below. In another example embodiment, the polyester polyol may have a glass transition temperature (Tg) of 1.2° C. or higher, 1.4° C. or higher, 1.6° C. or higher, 1.8° C. or higher, 2.0° C. or higher, or 2.2° C. or higher, or may have a glass transition temperature (Tg) of 17.5° C. or less, 17.0° C. or less, 16.5° C. or less, 16.0° C. or less, 15.8° C. or less, or 15.6° C. or less. The present disclosure may provide, by controlling the glass transition temperature of polyester polyol as described above, an adhesive with excellent adhesive strength and resistance to boiling water even when exposed to high temperature environments.

The present disclosure may provide, by controlling the properties of polyester polyol as described above, an adhesive for a battery packaging material that has excellent formability and exhibits excellent adhesive strength even at high temperatures, and with excellent resistance to boiling water by which there is no interlayer lifting phenomenon without a decrease in interlayer adhesive strength. These effects may be further improved through control of the characteristics described later herein.

For example, the polyester polyol may have a weight-average molecular weight (Mw) of 30,000 to 90,000 g/mol. For example, the weight-average molecular weight may be measured in a manner according to the Evaluation Example described below. In another example embodiment, the polyester polyol may have a weight-average molecular weight (Mw) of 35,000 g/mol or greater, 40,000 g/mol or greater, 45,000 g/mol or greater, 50,000 g/mol or greater, 55,000 g/mol or greater, or 60,000 g/mol or greater, or may have a weight-average molecular weight (Mw) of 85,000 g/mol or less, 80,000 g/mol or less, or 75,000 g/mol or less.

For example, the polyester polyol may have a polydispersity index (PDI) of 2 to 3. For example, the polydispersity index may be measured in a manner according to the Evaluation Example described below. In another example embodiment, the polyester polyol may have a polydispersity index (PDI) of 2.05 or greater or 2.1 or greater, or may have a polydispersity index (PDI) of 2.9 or less or 2.8 or less.

For example, the polyester polyol may have an acid value of 0.25 to 0.9 mgKOH/g. For example, the acid value of the above polyester polyol is the amount of free carboxyl group (—COOH) contained per 1 g of polyester polyol, expressed as mg of KOH, and may be measured by the method according to the Evaluation Example described below. In another example embodiment, the acid value of the above polyester polyol may be 0.3 mgKOH/g or greater, or may be 0.8 mgKOH/g or less or 0.7 mgKOH/g or less.

For example, the polyester polyol may have a hydroxyl value of 3.5 to 8 mgKOH/g. In another example embodiment, the hydroxyl value of the polyester polyol may be 3.7 mgKOH/g or greater or 3.9 mgKOH/g or greater, or may be 7.5 mgKOH/g or less, 7.0 mgKOH/g or less, 6.5 mgKOH/g or less, 6.0 mgKOH/g or less, or 5.5 mgKOH/g or less.

By controlling the acid value and/or hydroxyl value of polyester polyol as described above, provided may be the polyurethane adhesive of which curing density is improved with the excellent reactivity with the curing agent, and according thereto, having improved adhesiveness.

For example, the polyester polyol is derived from the reaction of a polyacid component and a polyalcohol component. For example, the polyester polyol may be a polymer chain with repeatedly linked ester bonds formed by the reaction between the carboxyl group of the polyacid component and the hydroxyl group of the polyalcohol component.

For example, the polyacid component may include at least one selected from a group consisting of an aromatic polyacid component composed of terephthalic acid, isophthalic acid, naphthalene dicarboxylic acid, phthalic anhydride and ester compounds thereof, and an aliphatic polyacid component composed of azelaic acid, dimerized fatty acids, adipic acid, sebacic acid, tetrahydrophthalic anhydride, hexahydrophthalic anhydride, succinic acid, glutaric acid, malonic acid, oxalic acid, pimelic acid and ester compounds thereof. In the present disclosure, the aromatic polyacid component refers to a polyacid component that contains an aromatic group, such as a benzene ring and a naphthalene ring, in its molecular structure, and the aliphatic polyacid component refers to a polyacid component having an aliphatic chain or ring, but not containing an aromatic ring. In the present disclosure, each of the tetrahydrophthalic anhydride and the hexahydrophthalic anhydride may be saturated.

For example, the molar content of the aromatic polyacid component relative to the total polyacid component of the polyester polyol may be 40 to 90 mol %. In another example embodiment, the molar content of the aromatic polyacid component with respect to the entire polyacid component of the polyester polyol may be 45 mol % or greater, 50 mol % or greater, 55 mol % or greater, or 60 mol % or greater, or may be 85 mol % or less, 80 mol % or less, 75 mol % or less, or 70 mol % or less. As the polyurethane adhesive satisfies the above range, the polyurethane adhesive may exhibit excellent adhesive strength even at high temperatures.

For example, the polyalcohol component may include at least one selected from a group consisting of neopentyl glycol, ethylene glycol, diethylene glycol, triethylene glycol, MP Diol (2-Methyl-1,3-propanediol), propylene glycol, dipropylene glycol, 1,6-hexanediol, 1,4-1,4-butylene glycol, 1,4-cyclohexanedimethanol, trimethylolpropane, glycerin, 1,9-nonanediol, polyether polyol, polycarbonate polyol, polyolefin polyol, acrylic polyol, polyurethane polyol, 1,2-butanediol, 1,3-butanediol, 1,2-hexanediol, 1,3-propanediol and pentaerythritol.

For example, the polyacid component may include (a) terephthalic acid, (b) isophthalic acid, and (c) azelaic acid or sebacic acid.

For example, the polyacid component may include (a) 20 to 45 mol % of terephthalic acid, (b) 25 to 35 mol % of isophthalic acid, and (c) 20 to 50 mol % of azelaic acid or sebacic acid. In the present disclosure, when azelaic acid and sebacic acid are both included, the mol % of azelaic acid or sebacic acid may indicate the combined mol % of azelaic acid and sebacic acid. In another example embodiment, the polyacid component may include (a) 30 to 40 mol % of terephthalic acid, (b) 28 to 30 mol % of isophthalic acid, or (c) 25 to 40 mol % of azelaic acid or sebacic acid.

For example, the polyacid component may further include more than 0 and less than 8 mol % of dimerized fatty acids. In another example embodiment, the polyacid component may include 1 mol % or greater, 2 mol % or greater, 3 mol % or greater, or 4 mol % or greater of dimerized fatty acids, or include 7 mol % or less or 6 mol % or less of dimerized fatty acids.

The polyalcohol component may include, for example, neopentyl glycol and ethylene glycol.

For example, the polyalcohol component may include 1 to 30 mol % of neopentyl glycol and 60 to 90 mol % of ethylene glycol. In another example embodiment, the polyalcohol component may contain 10 to 20 mol % of neopentyl glycol, or may contain 70 to 80 mol % of ethylene glycol.

For example, the polyalcohol component may further include MPD (3-Methyl-1,5-pentanediol) in an amount of more than 0 and less than or equal to 30 mol %. In another example embodiment, the polyalcohol component may further contain 15 to 25 mol % of MPD (3-Methyl-1,5-pentanediol).

In the present disclosure, by including the polyacid component and the polyalcohol component in the above combination and weight ratio, the polyester polyol having the above-described characteristics may be formed. Accordingly, provided may be the polyurethane adhesive of which adhesive strength is excellent not only in the room temperature but also in high temperatures and by which the phenomenon of lifting of a layer is controlled.

For example, the polyester polyol of the present disclosure may contain 70 mol to 120 mol of polyacid component per 100 mol of polyalcohol component. In another example embodiment, the polyester polyol may include 75 mol or greater, 80 mol or greater, 85 mol or greater, or 90 mol or greater of a polyacid component per 100 mol of a polyalcohol component, or may include 115 mol or less, 110 mol or less, 105 mol or less, or 100 mol or less of a polyacid component per 100 mol of a polyalcohol component.

For example, the polyurethane adhesive may include 5 to 30 weight of a polyisocyanate curing agent per 100 weight of polyester polyol. The polyisocyanate curing agent may be in the form of polyisocyanate diluted with an organic solvent, or may be in the form of polyisocyanate not diluted. In the present disclosure, the weight ratio of the polyisocyanate curing agent and the polyester polyol may indicate, for example, the weight ratio of the solid content.

For example, the polyisocyanate curing agent may be at least one selected from aliphatic diisocyanates such as trimethylene diisocyanate, tetramethylene diisocyanate, hexamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, and 2,6-diisocyanate methyl caproate, aliphatic ring diisocyanates such as 1,4-cyclohexane diisocyanate, 1,3-cyclohexane diisocyanate, 3-isocyanate methyl-3,5,5-trimethyl cyclohexyl isocyanate, 4,4′-methylene bis(cyclohexyl isocyanate), methyl 2,4-cyclohexane diisocyanate, methyl 2,6-cyclohexane diisocyanate, 1,4-2(isocyanate methyl)cyclohexane, and 1,3-2(isocyanate methyl)cyclohexane, aromatic diisocyanates such as m-phenylene diisocyanate, p-phenylene diisocyanate, 4,4′-diphenyl diisocyanate, 1,5-naphthalene diisocyanate, 4,4′-diphenylmethane diisocyanate, 2,4- or 2,6-toluene diisocyanate, a mixture thereof, 4,4′-toluidine diisocyanate, dianisidine diisocyanate, and 4,4′-diphenyl ether diisocyanate, aromatic-aliphatic diisocyanates such as 1,3- or 1,4-xylene diisocyanate, a mixture thereof, ω, ω′-diisocyanate-1,4-diethylbenzene, 1,3- or 1,4-2(1-isocyanate-1-methylethyl)benzene and a mixture thereof, organic triisocyanates such as triphenylmethane-4,4′, 4″-triisocyanate, 1,3,5-triisocyanate benzene, and 2,4,6-triisocyanate toluene, polyisocyanate monomers such as organic tetraisocyanates such as 4,4′-diphenyl dimethyl methane-2,2′-5,5′-tetraisocyanate, dimers derived from the above polyisocyanate monomers, trimer, biuret, allophanate, carbon dioxide and a polyisocyanate having a 2,4,6-oxadiazinetrione ring obtainable from the polyisocyanate monomers. It may also be an adduct in which a glycol component, described below, is added to the polyisocyanate monomer. As a glycol component used in adduct formation, used may be adducts of low molecular polyols with molecular weights less than 200, such as ethylene glycol, propylene glycol, butylene glycol, hexylene glycol, neopentyl glycol, 1,6-hexanediol, 3-methyl-1,5-pentanediol, 3,3′-dimethylolpropane, cyclo hexane dimethanol, diethylene glycol, triethylene glycol, dipropylene glycol, glycerol, trimethylolpropane, pentaerythritol, sorbitol, or may be polyester polyol with molecular weight 200˜20,000, polyether ester polyol, polyester amide polyol, polycaprolactone polyol, polyvalerolactone polyol, acrylic polyol, polycarbonate polyol, polyhydroxy alkane, castor oil, and polyurethane polyol.

For example, the polyurethane adhesives may further contain known additives. For example, the known additive may be contained in the main agent or curing agent, or may be introduced separately. For example, as the additive, heat stabilizer, hydrolysis stabilizer, reaction accelerator, leveling agent and defoaming agent may be used, but the additive is not limited thereto. For example, the heat stabilizer may be at least one selected from the group consisting of zinc oxide, magnesium oxide, triphenylphosphate, phosphite ester, bisphenol A based stabilizer, thioether, hydrotalcite, sepiolite or organic silicone based additive. For example, the hydrolysis stabilizer may be at least one selected from the group consisting of trialkyl phosphite, phosphonate, polycarbodiimide, blocking agent, silicone derivative, calcium carbonate, hydrotalcite, and phenol-based stabilizer. For example, the reaction accelerator may be at least one selected from the group consisting of a metal-based catalyst such as dibutyltin diacetate, dibutyltin dilaurate, dioctyltin dilaurate and dibutyltin D-maleate, tertiary amines such as 8-diaza-bicyclo(5,4,0)undecene-7,1,5-diazabicyclo(4,3,0)nonen-5,6-2butylamino-1,8-diazabicyclo(5,4,0)uncene-7, and a reactive tertiary amine such as triethanolamine. For example, the leveling agent may be at least one selected from the group consisting of polyether modified-polydimethylsiloxane, polyester modified-polydimethylsiloxane, aralkyl modified-polymethylalkylsiloxane, polydimethylsiloxane containing polyester modified-hydroxyl group, polydimethylsiloxane containing polyether ester modified-hydroxyl group, acrylic copolymer, methacrylic copolymer, polyether modified-polymethylalkylsiloxane, acrylic acid alkyl ester copolymer, methacrylic acid alkyl ester copolymer and lecithin. For example, the defoaming agent may be at least one selected from silicone resin, silicone solution, alkyl vinyl ether, acrylic acid alkyl ester, and methacrylic acid alkyl ester copolymer.

For example, the polyurethane adhesive may further contain a solvent. For example, the solvent may be at least one selected from ketone compounds such as acetone, methylethylketone, methyl isobutyl ketone and cyclohexanone, ester based compounds such as acetic acid methyl, acetic acid ethyl, acetic acid butyl, lactic acid ethyl and acetic acid methoxy ethyl, ether based compounds such as diethyl ether and ethylene glycol dimethyl ether, an aromatic compound such as toluene and xylene, aliphatic compounds such as pentane and hexane, halogenated hydrocarbon compounds such as dichloromethylene, chlorobenzene and chloroform, an alcohol group such as ethanol, isopropyl alcohol and normal butanol, and water. The solvent may be included in the main agent or curing agent, and may be used to appropriately adjust the viscosity when coating the adhesive on a substrate.

The second aspect of the present disclosure relates to a packaging material for batteries.

The matters related to the first aspect of the present disclosure are equally applicable to matters related to the second aspect unless specifically stated otherwise.

For example, the packaging material for batteries may be sequentially laminated in the order of an outer resin film layer, an outer adhesive layer, a metal foil layer, an inner adhesive layer and a heat sealing layer. For example, as a sealed packaging material that protects battery cells and prevents external impact, the packaging material for batteries may indicate a protective container or an outer material containing battery cells. In the present disclosure, the term “inner” refers to the internal space direction where the battery cells are located when the battery cells are sealed by the packaging material for batteries, and the term “outer” refers to the direction of the outer space where the battery cells are not located when the battery cells are sealed by the packaging material for batteries.

For example, the packaging material for batteries may include a polyurethane adhesive according to the first aspect as the outer adhesive layer. As the outer adhesive layer includes the aforementioned polyurethane adhesive, the packaging material for batteries may have excellent formability, and exhibit adhesive strength by which there is no lifting of a layer even at high temperatures.

The outer adhesive layer and/or the inner adhesive layer may be formed by applying and curing each of the outer adhesive and the inner adhesive on at last one of the outer resin film layer, the metal foil layer and the heat sealing layer. For example, the application may be performed by comma coating, roll knife coating, die coating, roll coating, bar coating, gravure roll coating, reverse roll coating, blade coating, gravure coating, microgravure coating or a dry-laminator. For example, the curing may be thermal curing or UV curing, and may preferably be thermal curing.

For example, the outer resin film layer may be a stretched film such as polyamide film, polyester film and nylon. The outer resin film may be colored with pigments such as carbon black and titanium oxide, and the outer resin film layer may be coated with a coating agent, such as a damage-preventing coating agent, or ink. Accordingly, mechanical damage or chemical damage may be prevented, and the batteries may operate stably even at high temperatures and/or high pressures. For example, the thickness of the outer resin film layer may be 5 to 50 μm, but the thickness is not limited thereto.

For example, the metal foil layer may be an aluminum foil layer. With the metal foil layer, the packaging material for batteries may have excellent resistance to boiling water and moisture resistance, and the metal foil layer may contribute to extending the life of the battery by blocking moisture and oxygen from the external environment of the battery cell. For example, the metal foil layer may be surface-treated with phosphate, chromate, fluoride, triazinethiol compound, or isocyanate compound. The treatment may prevent the phenomenon of interlayer lifting due to electrolyte, and the resistance to boiling water and stability may be improved by the above treatment. For example, the thickness of the metal foil layer may be 30 to 100 μm, but is not limited thereto.

For example, the inner adhesive layer may be formed by a known adhesive that does not reduce the adhesive strength of the metal foil layer and the heat sealing layer depending on the electrolyte. As the known adhesive, an adhesive combining polyolefin resin and multi-functional isocyanate or an adhesive combining polyol and multi-functional isocyanate may be used. However, the adhesive is not limited thereto.

For example, as a polyolefin film, the heat sealing layer may be an unstretched film including at least one thermoplastic resin selected from the group consisting of polyethylene, polypropylene, olefin-based copolymer, acid modified products thereof, and ionomers. The thickness of the heat sealing layer may be, for example, 40 to 80 μm, but the thickness is not limited thereto.

Hereinafter, example embodiments will be described in detail to specifically explain the disclosure of the present disclosure and the intended functions and effects of the present disclosure as described above. However, the example embodiments may be modified in many different forms, and the scope of the present disclosure should not be construed as being limited to the example embodiments. It is emphasized that the example embodiments are provided to more specifically describe the present disclosure to those skilled in the art.

### Example 1

### Manufacturing the “Main Agent”

A polyacid component consisting of 37 mol % of terephthalic acid, 28 mol % of isophthalic acid, and 35 mol % of azelaic acid and a polyalcohol component consisting of 20 mol % of neopentyl glycol and 80 mol % of ethylene glycol are mixed in a molar ratio of 1:1 in a reactor equipped with a thermometer, agitator, a circulating cooling pipe and a distillation apparatus. 12 ppm of tetra-n-butyltitanate is added as a catalyst to the mixture and the mixture is heated from 160 to 240° C. over 4 hours for ester exchange reaction. In addition, the pressure is reduced to 5 mmHg over 20 minutes, and a polycondensation reaction is further performed at 260° C. for 90 minutes under a vacuum of 0.3 mmHg or less, to obtain a solid polyester polyol a.

The acid value of the obtained polyester polyol a is 0.30 mgKOH/g, the hydroxyl value is 5.31 mgKOH/g, the number-average molecular weight (Mn) is 26,000 g/mol, the weight-average molecular weight (Mw) is 60,000 g/mol, PDI was 2.31, and the glass transition temperature was 9.1° C.

Further, the polyester polyol a is dissolved in methyl ethyl ketone (MEK) to prepare a “main agent.” At this time, the weight ratio of polyester polyol a to MEK is 30:70.

### Manufacturing a Polyurethane Adhesive for a Battery Packaging Material

The above-mentioned “main agent” and polyisocyanate curing agent (TDI Adduct Type contains 75% solid content, and the remaining 25% is composed of acetic acid ethyl solvent) are mixed at a weight ratio of 100:10 at room temperature, stirred for 10 minutes, and then diluted with MEK to produce a polyurethane adhesive having a concentration of solid content of 7%.

### Manufacturing a Packaging Material for Batteries

On one side of a 40 μm thick aluminum foil, 0.03 g/m² of coating-type phosphate chromate treatment agent (Nippon Paint Co., Ltd., Surfcoat NR-X) is applied, and baked at a temperature of 230° C. Thereafter, using a dry-laminator, the previously surface-treated side of the aluminum foil is coated with the above-prepared polyurethane adhesive as an outer adhesive layer, the solvent is evaporated, and a 25 μm-thick stretched polyamide film is laminated. The coating amount after drying of the adhesive is 3 g/m².

Next, an inner adhesive, which will be described below, is applied to the other side of the aluminum foil, and after solvent evaporation, a 25 μm-thick unstretched polypropylene film is laminated to obtain a laminate. The coating amount after drying of the adhesive is 3 g/m². At this time, as the inner adhesive, a mixture of AD-502 (Toyo Morton Co., Ltd., polyester polyol) as the main agent and CAT-10L (Toyo Morton Co., Ltd., isocyanate-based curing agent) as the curing agent is used, prepared at a weight ratio of 100:10 (main agent:curing agent), adjusted to a solid content concentration of 25% with ethyl acetate.

Subsequently, the obtained laminate is aged at 60° C. for 7 days to obtain a packaging material for batteries.

### Example 2 to 4 and Comparative Example 1 to 9

Except that polyester polyols as shown in Table 1 below are introduced instead of polyester polyol a, a polyurethane adhesive for battery packaging material and a packaging material for batteries are manufactured in the same manner as in Example 1.

TABLE 1

| Composition of polyester | | Example | Example | Example | Example | Example | Example | Example |
|---|---|---|---|---|---|---|---|---|
| polyol | | 1 | 2 | 3 | 4 | 5 | 6 | 7 |
| Polyacid | TPA | 30 | 40 | 37 | 37 | 40 | 40 | 40 |
| component | IPA | 30 | 30 | 28 | 28 | 30 | 30 | 30 |
| (mol %) | AdA | — | — | — | — | — | — | — |
| | SeA | — | — | — | 35 | — | — | 10 |
| | AzA | 40 | 30 | 35 | — | 25 | 30 | 20 |
| | Propol | — | — | — | — | 5 | — | — |
| | 1009 | | | | | | | |
| Subtotal | | | | | | | | |
| Polyalcohol | NPG | 20 | 20 | 20 | 20 | 20 | 10 | 10 |
| component | EG | 80 | 80 | 80 | 80 | 80 | 70 | 70 |
| (mol %) | MPD | — | — | — | — | — | 20 | 20 |
| Subtotal | | 100 | 100 | 100 | 100 | 100 | 100 | 100 |
| Mol content (mol %) of | | 60 | 70 | 65 | 65 | 70 | 70 | 70 |
| aromatic polyacid | | | | | | | | |
| component relative to the | | | | | | | | |
| total polyacid component | | | | | | | | |
| of polyester polyol | | | | | | | | |
| Molecular | Mn | 27,000 | 23,000 | 26,000 | 29,000 | 29,000 | 29,000 | 31,000 |
| weight | Mw | 69,000 | 64,000 | 60,000 | 63,000 | 71,000 | 62,000 | 66,000 |
| | Mw/Mn | 2.56 | 2.78 | 2.31 | 2.17 | 2.45 | 2.14 | 2.13 |
| Glass transition | | 2.2 | 15.6 | 9.1 | 5.0 | 10.8 | 7.1 | 7.1 |
| temperature, Tg(° C.) | | | | | | | | |
| Properties | Acid | 0.42 | 0.7 | 0.30 | 0.31 | 0.51 | 0.66 | 0.66 |
| | value | | | | | | | |
| | (ml | | | | | | | |
| | KOH/g) | | | | | | | |
| | Hydroxyl | 4.00 | 4.40 | 5.31 | 5.00 | 4.20 | 4.20 | 5.40 |
| | value | | | | | | | |

| Composition of polyester | | Comparative | Comparative | Comparative | Comparative | Comparative | Comparative |
|---|---|---|---|---|---|---|---|
| polyol | | example 1 | example 2 | example 3 | example 4 | example 5 | example 6 |
| Polyacid | TPA | 40 | 30 | 30 | 40 | 20 | 40 |
| component | IPA | 10 | 20 | 20 | 10 | 20 | 30 |
| (mol %) | AdA | — | — | 20 | — | — | — |
| | SeA | 30 | 30 | — | 30 | 40 | — |
| | AzA | 20 | 20 | 30 | 20 | 20 | 30 |
| | Propol | — | — | — | — | — | — |
| | 1009 | | | | | | |
| Subtotal | | 100 | 100 | 100 | 100 | 100 | 100 |
| Polyalcohol | NPG | 40 | 28 | 20 | 55 | 20 | 20 |
| component | EG | 60 | 40 | 80 | 45 | 80 | 80 |
| (mol %) | MPD | — | 32 | — | — | — | — |
| Subtotal | | 100 | 100 | 100 | 100 | 100 | 100 |
| Mol content (mol %) of | | 50 | 50 | 50 | 50 | 40 | 70 |
| aromatic polyacid | | | | | | | |
| component relative to the | | | | | | | |
| total polyacid component | | | | | | | |
| of polyester polyol | | | | | | | |
| Molecular | Mn | 31,000 | 28,000 | 26,000 | 29,000 | 34,000 | 6,806 |
| weight | Mw | 71,000 | 64,000 | 68,000 | 75,000 | 100,000 | 14,000 |
| | Mw/Mn | 2.29 | 2.29 | 2.62 | 2.59 | 2.94 | 2.06 |
| Glass transition | | −8 | −18 | −6.5 | −7 | −23 | 7.4 |
| temperature, Tg(° C.) | | | | | | | |
| Properties | Acid | 0.12 | 0.99 | 0.17 | 0.15 | 0.22 | 0.26 |
| | value | | | | | | |
| | (ml | | | | | | |
| | KOH/g) | | | | | | |
| | Hydroxyl | 4.30 | 2.73 | 4.48 | 5.13 | 5.13 | 28.70 |
| | value | | | | | | |
| | (ml | | | | | | |
| | KOH/g) | | | | | | |

(TPA: terephthalic acid, IPA: isophthalic acid, AdA: adipic acid, SeA: sebacic acid, AzA: azelaic acid, Propol 1009: dimerized fatty acids, NPG: neopentyl glycol, EG: ethylene glycol, MP Diol: 2-methyl-1,3-propanediol)

### Evaluation Example 1. Number-Average Molecular Weight (Mn), Weight-Average Molecular Weight (Mw), and Polydispersity Index (PDI, Mw/Mn) of Polyester Polyols

A sample is prepared for measurement by dissolving or diluting polyester polyol in tetrahydrofuran (THF) to a concentration of approximately 0.5% and filtering it using a membrane filter (polytetrafluoroethylene (PTFE)) with a diameter (pore size) of 0.5 μm. Tetrahydrofuran is used as a mobile phase, and if the sample does not dissolve in THE, N,N-dimethylformamide is used as an alternative solvent.

In the gel permeation chromatography (GPC) analysis, the number-average molecular weight (Mn) and weight-average molecular weight (Mw) are measured using a refractive index detector (RID).

The columns used are KF-802, 804L, and 806L manufactured by Showa Denko (Resonac) and the column temperature is set to 30° C. and the flow rate is set to 1 ml/min. The system is calibrated using monodisperse polystyrene as a molecular weight standard. Additionally, based on Mn and Mw, the polydispersity index (PDI, Mw/Mn) is calculated, and the molecular weight distribution is evaluated.

### Evaluation Example 2. Glass Transition Temperature (Tg) of Polyester Polyol

The glass transition temperature (Tg) of polyester polyol is measured using differential scanning calorimetry (DSC) model ┌RDC 220┘ from Seiko Instruments Inc. About 10 mg of polyester polyol is placed in an aluminum pan and set in the DSC device, and is cooled to −100° C. using liquid nitrogen and then heated at 10° C./min. The glass transition temperature is calculated based on the midpoint of the heat capacity change in the capacity change curve (DSC thermogram) obtained through the DSC measurement. When polyester polyol is dissolved in a solvent, after removing the solvent by distillation and drying under vacuum to completely remove the remaining solvent, the DSC analysis is performed.

### Evaluation Example 3. Acid Value of Polyester Polyol

Approximately 1 g of polyester polyol is accurately weighed and placed into a stoppered Erlenmeyer flask, and 100 ml of a solvent containing toluene and ethanol mixed at a weight ratio of 2:1 is added to completely dissolve the sample. Then 3 to 4 drops of phenolphthalein indicator are added, and the solution is shaken until a stable pale pink color is maintained, and 0.1N alcoholic potassium hydroxide solution is used for titration. The acid value is calculated using the following formula (Unit: mgKOH/g).

$$acid value ( mgKOH / g ) = ( 5.611 \times a \times F ) / S$$

where, S is the weight (g) of the sample, a is the amount (ml) of 0.1N alcoholic potassium hydroxide solution consumed, and F is the titer of 0.1N alcoholic potassium hydroxide solution.

However, if the sample is not completely dissolved, the solvent composition is adjusted or the solvent is remixed before titration to ensure complete dissolution.

### Evaluation Example 5. Hydroxyl Value of Polyester Polyol

Approximately 1 g of polyester polyol is accurately weighed and added into the Erlenmeyer flask or a conical flask with a stopper. 100 ml of a solvent mixture of toluene and ethanol in a weight ratio of 2:1 is added to completely dissolve the polyester polyol. Subsequently, 5 ml of an acetylating agent (based on 100 ml) prepared by dissolving 25 g of acetic anhydride in pyridine is added, and the mixture is stirred at room temperature for approximately 1 hour to allow the reaction to proceed. After the reaction, 3-4 drops of phenolphthalein indicator are added, and titration is carried out using 0.1N alcoholic potassium hydroxide solution until a pale pink color persisted. A blank experiment (b) is conducted under the same conditions to determine the consumption of acetic anhydride. The hydroxyl value is calculated using the following formula (Unit: mgKOH/g).

$$hydroxyl value ( mgKOH / g ) = [ \{ ( b - a ) \times F \times 28.25 \} / S ] + D$$

where S is the weight (g) of the sample, a is the volume (lm) of 0.1N alcoholic potassium hydroxide solution consumed, b is the volume (ml) of 0.1 N alcoholic potassium hydroxide solution consumed in the blank experiment, F is the titer of 0.1 N alcoholic potassium hydroxide solution, and D is an acid value (mgKOH/g).

### Evaluation Example 6. Adhesive Strength (Peel Strength) of Polyurethane Adhesive at Room Temperature/High Temperature

The packaging material for batteries is cut into pieces measuring 200 mm×15 mm, and a total of 20 specimens are prepared. A T-type peel test is performed on the prepared specimens using a universal testing machine (UTM), and the peel strength (N/15 mm) between stretched polyamide film and aluminum foil is measured.

The experimental conditions are as follows:
10 specimens are tested at a peel speed of 50 mm/min in a room temperature environment; and
the remaining 10 specimens are tested at a peeling speed of 50 mm/min in a high temperature (120° C.) environment.

The peel strength values of 10 specimens measured under each condition are averaged and regarded as the room temperature and high temperature adhesive strength of the polyurethane adhesive, and the results are shown in Table 2 below.

### Evaluation Example 7. Resistance to Boiling Water of Polyurethane Adhesive

Blanks are prepared by cutting the packaging material for batteries into a size of 60 mm×60 mm. With respect to the blank, a molded article is manufactured by performing a single-stage protrusion molding with a molding height of 5 mm using a straight mold with a molding height free, with the stretched polyamide film facing the outside. A total of 10 molded articles are produced in this manner. Further, results of visually checking whether there is any peeling after immersing 10 molded articles in boiling water at 100° C. for 1 hour are shown in Table 2 below.

TABLE 2

| | | | Resistance to |
|---|---|---|---|
| | Adhesive strength(N/15 mm) | | boiling water |
| | Adhesive | Adhesive | (Number of |
| | strength at | strength | peeled samples/ |
| | a room | at a high | Number of |
| | temperature | temperature | evaluated |
| | (Room temp.) | (120° C.) | samples) |
| Example 1 | 9.5 | 5.4 | 0/10 |
| Example 2 | 9.4 | 5.3 | 0/10 |
| Example 3 | 10.5 | 5.2 | 0/10 |
| Example 4 | 8.8 | 5.2 | 0/10 |
| Example 5 | 8.5 | 5.9 | 0/10 |
| Example 6 | 9.1 | 6.6 | 0/10 |
| Example 7 | 8.4 | 6.0 | 0/10 |
| Comparative | 8.3 | 5.4 | 7/10 |
| example 1 | | | |
| Comparative | 9 | 7.6 | 10/10 |
| example 2 | | | |
| Comparative | 8.5 | 5.4 | 6/10 |
| example 3 | | | |
| Comparative | 8.5 | 5.2 | 2/10 |
| example 4 | | | |
| Comparative | 8.5 | 7.2 | 9/10 |
| example 5 | | | |
| Comparative | 10.0 | 4.0 | 5/10 |
| example 6 | | | |

1. A polyurethane adhesive for a battery packaging material, the polyurethane adhesive comprising a main agent and a polyisocyanate curing agent,
wherein the main agent comprises polyester polyol of which number-average molecular weight (Mn) is 20,000 to 33,000 gram per mol (g/mol) and a glass transition temperature is 1 to 18° C.,
wherein the polyester polyol is derived from reaction of a polyacid component and a polyalcohol component, and
wherein the polyacid component comprises an aromatic polyacid component and an aliphatic polyacid component.

2. The polyurethane adhesive of claim 1, wherein a weight-average molecular weight (Mw) of the polyester polyol is 30,000 to 90,000 g/mol.

3. The polyurethane adhesive of claim 1, wherein polydispersity index (PDI) of the polyester polyol is 2 to 3.

4. The polyurethane adhesive of claim 1, wherein an acid value of the polyester polyol is 0.25 to 0.9 milligrams of potassium hydroxide per gram (mgKOH/g).

5. The polyurethane adhesive of claim 1, wherein a hydroxyl value of the polyester polyol is 3.5 to 8 mgKOH/g.

6. (canceled)

7. The polyurethane adhesive of claim 1, wherein
the aromatic polyacid component is selected from the group consisting of terephthalic acid, isophthalic acid, naphthalene dicarboxylic acid, phthalic anhydride and ester compounds thereof; and
the aliphatic polyacid component is selected from the group consisting of azelaic acid, dimerized fatty acids, adipic acid, sebacic acid, tetrahydrophthalic anhydride, hexahydrophthalic anhydride, succinic acid, glutaric acid, malonic acid, oxalic acid, pimelic acid and ester compounds thereof.

8. The polyurethane adhesive of claim 7, wherein molar content of the aromatic polyacid component relative to a total polyacid component of the polyester polyol is 40 to 90 mol %.

9. The polyurethane adhesive of claim 1, wherein the polyalcohol component comprises at least one selected from a group consisting of neopentyl glycol, ethylene glycol, diethylene glycol, triethylene glycol, MP Diol (2-Methyl-1,3-propanediol), propylene glycol, dipropylene glycol, 1,6-hexanediol, 1,4-1,4-butylene glycol, 1,4-cyclohexanedimethanol, trimethylolpropane, glycerin, 1,9-nonanediol, polyether polyol, polycarbonate polyol, polyolefin polyol, acrylic polyol, polyurethane polyol, 1,2-butanediol, 1,3-butanediol, 1,2-hexanediol, 1,3-propanediol and pentaerythritol.

10. The polyurethane adhesive of claim 1, wherein the polyacid component comprises (a) terephthalic acid, (b) isophthalic acid, and (c) azelaic acid or sebacic acid.

11. The polyurethane adhesive of claim 1, wherein the polyacid component comprises (a) 20 to 45 mol % of terephthalic acid, (b) 25 to 35 mol % of isophthalic acid, and (c) 20 to 50 mol % of azelaic acid or sebacic acid.

12. The polyurethane adhesive of claim 11, wherein the polyacid component further comprises greater than 0 and less than or equal to 8 mol % dimerized fatty acids.

13. The polyurethane adhesive of claim 1, wherein the polyalcohol component comprises neopentyl glycol and ethylene glycol.

14. The polyurethane adhesive of claim 1, wherein the polyalcohol component comprises 1 to 30 mol % of neopentyl glycol and 60 to 90 mol % of ethylene glycol.

15. The polyurethane adhesive of claim 14, wherein the polyalcohol component further comprises greater than 0 and less than or equal to 30 mol % MPD (3-Methyl-1,5-pentanediol).

16. The polyurethane adhesive of claim 1, wherein the polyester polyol comprises 70 to 120 mol of polyacid component per 100 mol of polyalcohol component.

17. The polyurethane adhesive of claim 1, wherein the polyisocyanate curing agent is included in an amount of 5 to 30 parts by weight per 100 parts by weight of the polyester polyol.

18. A packaging material for batteries comprising:
an outer resin film layer, an outer adhesive layer, a metal foil layer, an inner adhesive layer and a heat sealing layer, which are sequentially laminated,
wherein the outer adhesive layer comprises a polyurethane adhesive for a battery packaging material, the polyurethane adhesive comprising a main agent and a polyisocyanate curing agent, and
wherein the main agent comprises polyester polyol of which number-average molecular weight (Mn) is 20,000 to 33,000 g/mol, and of which glass transition temperature is 1 to 18° C.,
wherein the polyester polyol is derived from reaction of a polyacid component and a polyalcohol component, and
wherein the polyacid component comprises an aromatic polyacid component and an aliphatic polyacid component.

19. The packaging material for batteries of claim 18, wherein the outer resin film layer is a polyamide film, a polyester film or nylon, and the heat sealing layer is a polyolefin film.
